(19) United States
(12) Patent Application Publication
(10) Pub. No.: US 2018/0365189 A1
(43) Pub. Date: Dec. 20, 2018

(54) Method and Apparatus for Device Identification Using a Serial Port

(71) Applicant: Bernoulli Enterprise, Inc., Milford, CT (US)

(72) Inventors: Joseph Purcell McGuire, Orange, CT (US); Michael Lawrence Portnoy, Gladwyne, PA (US); Robert Craig Spikol, Moorestown, NJ (US); James A. Ricker, Shelton, CT (US)

(73) Assignee: Bernoulli Enterprise, Inc., Milford, CT (US)

(21) Appl. No.: 15/624,889

(22) Filed: Jun. 16, 2017

(51) Int. Cl. G06F 13/42; G06F 13/40

(52) U.S. Cl. CPC G06F 13/4286; G06F 2213/0002; G06F 13/4022

(57) ABSTRACT

A method of detecting the presence of a specific medical device connected to a computer by an RS232 serial line. In one embodiment, the method includes the steps of providing an RS232 connector having a specified computer side output pin connected to specific device specified computer side input pins; raising the voltage high on the specified computer side output pin; determining which computer side input pins are voltage high; and signaling which external medical device is in communication with the computer in response to which computer side input pins are voltage high. In another embodiment, the computer side output pin is selected from one of the data terminal ready (DTR) and ready to send (RTS) pins. In yet another embodiment, the computer side input pins are selected from one or more of data set ready DSR, data carrier detect (CD) and clear to send (CTS).

### FIELD OF THE INVENTION

The invention relates generally to the field of device identification and more specifically to devices connected to serial ports.

### BACKGROUND OF THE INVENTION

Devices connected to computers must be identified in some fashion so that the computer can decide what the device is, and what device drivers should be used to communicate with it and to make use of its functionality. Some devices identify themselves to the computer upon connection. Many others do not, and so must be identified to the computer upon configuration or connection to the computer.

This is somewhat problematic because it does not result in the plug-and-play functionality that is generally expected. Further, if the connection between the device and the computer is modified, for example by changing the connection port, the new connection must be identified to the computer manually.

What is needed is a method and apparatus for self-identification for devices without this capability. The present invention addresses this need.

### SUMMARY OF THE INVENTION

In one aspect, the invention relates to a method of detecting the presence of a specific medical device connected to a computer by an RS232 serial line. In one embodiment, the method includes the steps of providing an RS232 connector having a specified computer side output pin connected to specific device specified computer side input pins; raising the voltage high on the specified computer side output pin; determining which computer side input pins are voltage high; and signaling which external medical device is in communication with the computer in response to which computer side input pins are voltage high. In another embodiment, the computer side output pin is selected from one of the data terminal ready (DTR) and ready to send (RTS) pins. In yet another embodiment, the computer side input pins are selected from one or more of data set ready DSR, data carrier detect (CD) and clear to send (CTS). In still yet another embodiment, the computer side output pin is connected to two or more computer side input pins.

In another aspect, the invention relates to a method of detecting the presence of a specific external device connected to a computer by a communication line. In one embodiment, the method includes the steps of providing an communication line connector having a specified computer side output pin connected to specific device specified computer side input pins; raising the voltage high on the specified computer side output pin; determining which computer side input pins are voltage high; and signaling which external device is in communication with the computer in response to which computer side input pins are voltage high.

In still another aspect, the invention relates to a connector for designating what type of external device is connected to a computer through a serial RS232 line. In one embodiment, the connector includes an RS232 connector in which at least one of the data terminal ready (DTR) and ready to send (RTS) pins is connected to one or more of data set ready DSR, data carrier detect (CD) and clear to send (CTS) in accordance to the type of external device connected to the computer.

### BRIEF DESCRIPTION OF THE DRAWINGS

The structure and function of the invention can be best understood from the description herein in conjunction with the accompanying figures. The figures are not necessarily to scale, emphasis instead generally being placed upon illustrative principles. The figures are to be considered illustrative in all aspects and are not intended to limit the invention, the scope of which is defined only by the claims.

FIG. 1 is a diagram of an embodiment of a system utilizing the invention;

FIG. 2 is a diagram of an embodiment of a standard nine pin RS-232 serial port pin configuration;

FIG. 3 is a table of the signal nomenclature of the pins of the connector of FIG. 2;

FIG. 4 is a diagram of an embodiment of a configuration of wiring to designate one type of device; and

FIG. 5 is a diagram of an embodiment of a configuration of wiring to designate another type of device.

### DESCRIPTION OF A PREFERRED EMBODIMENT

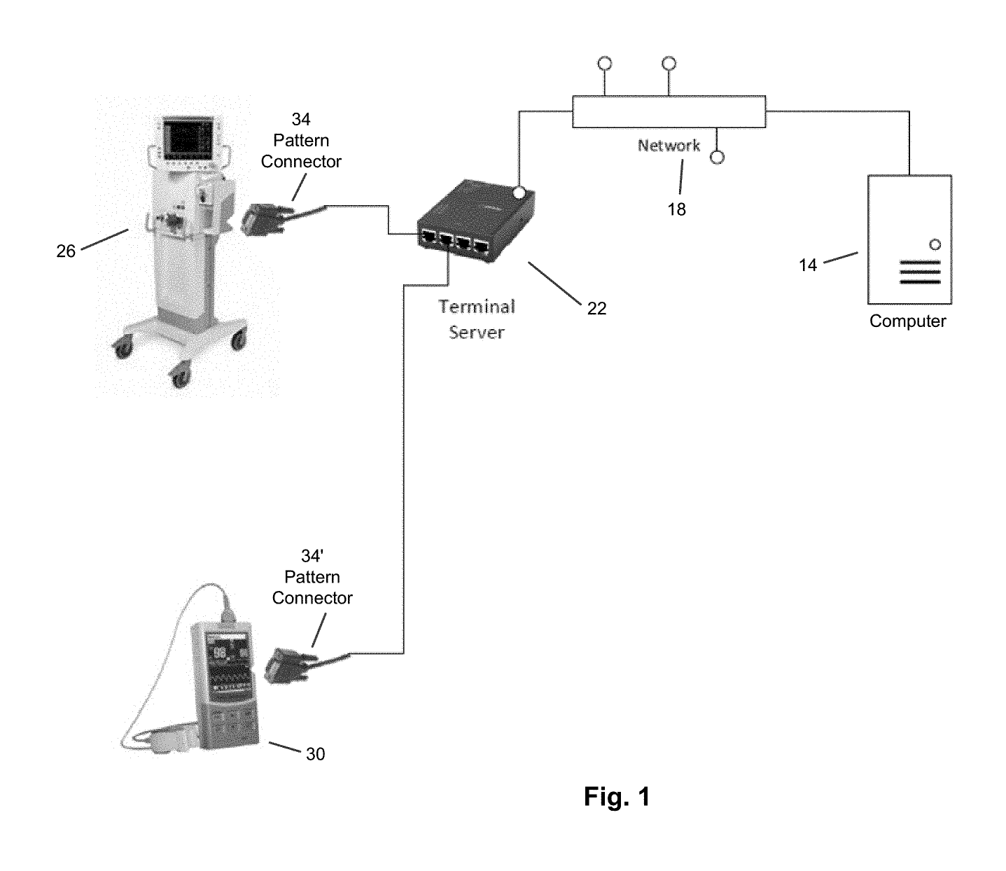

In brief overview and referring to FIG. 1, an embodiment of a system 10 is depicted in which the invention is used. In this embodiment, a computer 14 is connected through a network 18 to a bridge 22 acting as a device server to connect the devices to the network 18. Medical device 26, for example, in this embodiment, a ventilator, and medical device 30, for example, in this embodiment, an oximeter, are connected to the bridge 22 through the connectors 34, 34′ of the invention.

A connector constructed in accordance with the invention is constructed on a serial RS232 connector. In one embodiment, the connector is a DB9 connector, but other RS232 connectors such as the DB25 RS232 connector or other connectors having similar properties to the RS232 connector, described below, may be used. In addition, if the device connected to uses a different type of communication, such as a parallel port, a connector for the parallel port can also be used. The RS232 connector is generally used to connect a computer to an external device for serial communication and has multiple pins that carry data or control information between the computer and the device.

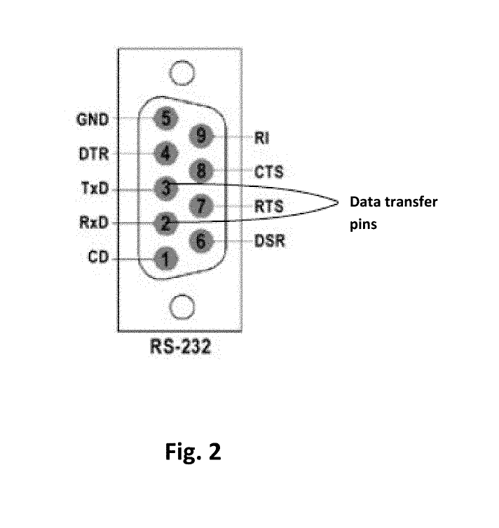

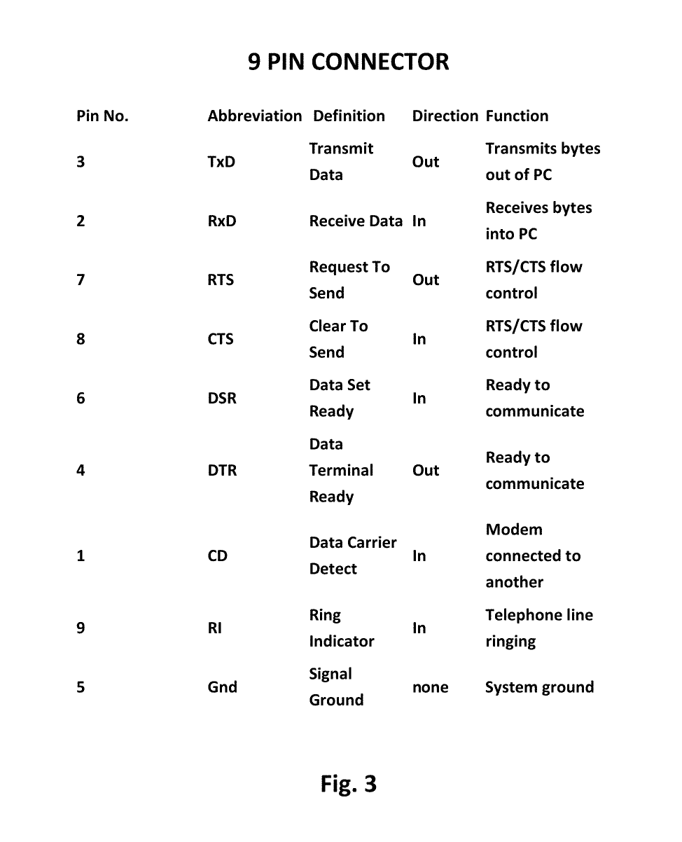

The pin designations for a standard DB9 RS232 connector are shown in FIG. 2 and FIG. 3. The connector has nine pins, each with a designated function or signal, that are generally controlled by a computer or the external device to which the computer is connected. Pin 1 is a data carrier detect (CD) pin that allows two modems connected together to communicate. Pin 2 is a receive data (RxD) pin that takes data into the computer from the external device. Pin 3 is a transmit data (TxD) pin that transmits data from the computer to the external device. Pin 4 is a data terminal ready (DTR) pin that the computer uses to inform the external device that it is ready to communicate. Pin 5 is a common ground (GND) pin between the computer and the external device. Pin 6 is data set ready (DSR) pin that the external device uses to tell the computer that the external device is ready to receive data. Pin 7 is a request to send (RTS) pin that the computer uses to tell the external device that it has data to send. Pin 8 is the clear to send (CTS) pin that the external device uses to tell the computer that it may send data to the external device. Pin 9 is a ring indicator (RI) pin that is used by the telephone network to indicate a call is being received.

The pins that are controlled by the computer side are pins 3 (TxD), 4 (DTR), and 7 (RTS). The pins controlled by the device are pins 2 (RxD), 6 (DSR), and 8 (CTS). The remaining pins 1 (CD), 5 (GND), and 9 (RI) are either passive (GND) or controlled by another device (for example, CD, a modem, and RI, the telephone network).

Many modern devices do not use most of the pins when communicating with a computer. As a result, these unused pins will not normally have signals on them. It is therefore the purpose of this invention to use these normally unused pins to permit the computer to determine what device is connected to the computer. To do this, the computer places a signal on a designated one of its output pins and reads signals on one or more of its input pins.

In one embodiment, the system 10 transmits data between the computer 14 and the external medical devices 26, 30. Pins 2 and 3, (T×D) and (R×D) respectively, are used to exchange data between the computer 14 and the external medical device 26, 30. In this configuration, the transmit data (TxD) pin of the computer would be connected to the receive data (RxD) pin of the external medical device. The converse is also true. The transmit data (TxD) pin of the external medical device would be connected to the receive data (RxD) pin of the computer. These pins are used to exchange data, as is the standard practice.

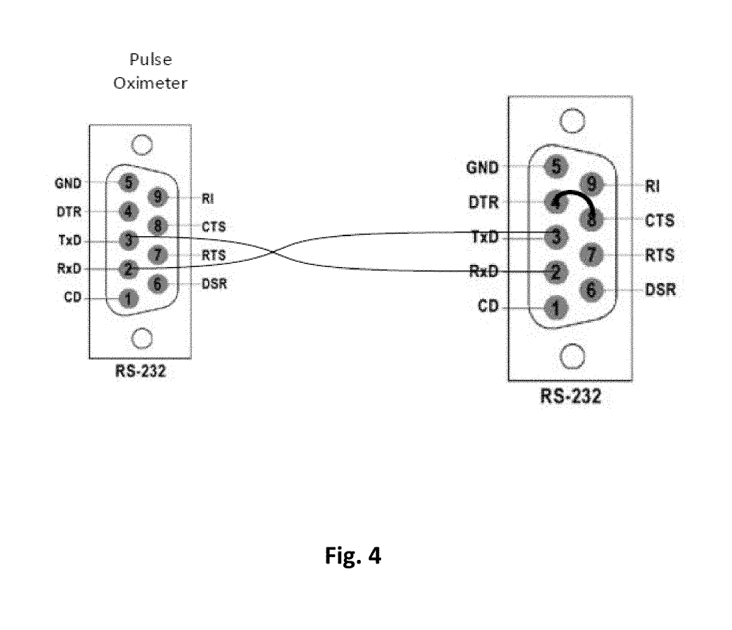

The remaining pins of the connector of the invention are joined by connecting a designated output pin from the computer with one or more of the remaining (non-output) pins in the connector. Referring to FIG. 4, in this example, to designate a pulse oximeter, the DTR output pin (4) from the computer is connected within the modified connector of the invention to the CTS pin (8) of the connector. Therefore, in use, the computer places a signal (raises the voltage high) on the DTR output pin (4) and then reads the non-output pins 1, 2, 6, 8, 9. The ground pin 5 cannot have a voltage placed on it, and so cannot be used for the purpose of identifying the external device. If the voltage detected by the computer is only high on pin 8, the computer determines that a pulse oximeter is connected to it.

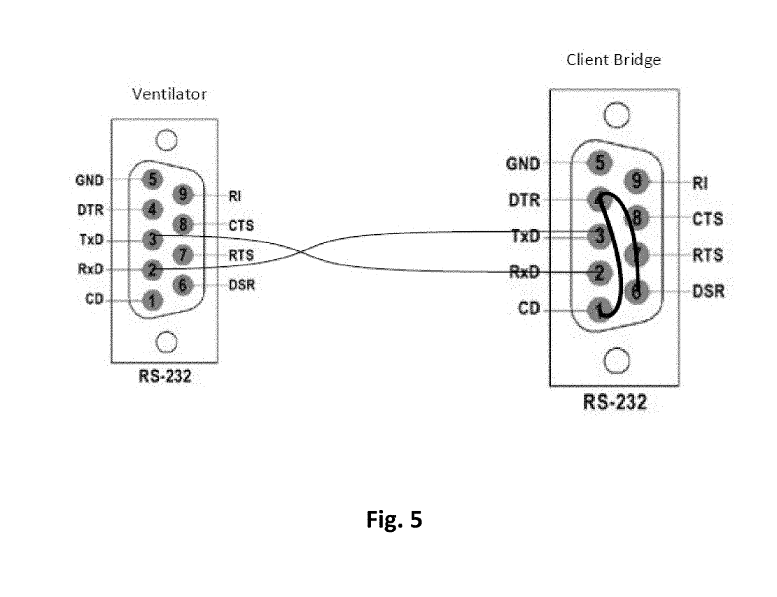

Similarly, referring to FIG. 5, if the DTR output pin 4 is connected to the CD pin 1 and DSR pin 6, the combination of pins, in this embodiment, designates a ventilator. When the computer reads the voltage on the non-output pins 1, 2, 6, 8, 9, it will detect a voltage high signal on pins 1 and 6. The following table shows the potential combinations of computer controlled output pins (DTR, RTS) and connected pins:

| | Connected Pin | | | Configuration |
|---|---|---|---|---|
| Source Pin | DSR | CD | CTS | Number |
| DTR | x | x | | 3 |
| DTR | x | | | 1 |
| DTR | | x | | 2 |
| DTR | x | x | x | 7 |
| DTR | | x | x | 5 |
| DTR | x | | x | 6 |
| DTR | | | x | 4 |
| RTS | x | x | x | 12 |
| RTS | | x | x | 11 |
| RTS | x | | x | 10 |
| RTS | | | x | 8 |
| RTS | x | | | 9 |
| RTS | x | x | | 13 |
| RTS | | x | | 14 |
| ALL | | | | 0 |

This set of connections generates fourteen unique signal combinations and therefore can identify fourteen different external devices. Once a cable has been configured to designate a certain type of external device, the cable is only used with that type of device.

Once the external device 30, 34 has been connected to the network 18 through the bridge 22 or directly to the computer 14, the computer 14 interrogates the RS232 ports either directly or through the terminal server 22 to determine what is connected to the computer. It performs this interrogation through the RS232 device driver using a modified RS232 driver.

The steps of the interrogation are generally:

Open the communication port to be interrogated:
Open Comm port

Once the communication port to be interrogated is open, set the configuration number (Line) to 0:
VAR Line=0

Set the output pin DTR voltage to HIGH:
Set DTR=HIGH

Check the voltage on the non-output pins and if voltage is HIGH, modify the configuration number:
Check DSR If HIGH Line=Line+1
Check CD If HIGH Line=Line+2
Check CTS If HIGH Line=Line+4

Once all the non-output pins have been checked, set the output pin RTS voltage to HIGH:
Set RTS=HIGH

Check the voltage on the non-output pins and if voltage is HIGH, modify the configuration number:
Check DSR If HIGH Line=Line+8
Check CD If HIGH Line=Line+16
Check CTS If HIGH Line=Line+32

Once all variations have been checked, the configuration number (Line) is returned to the calling program:
Return Line

The program then calls the routines to connect the proper code module (VENTILATOR and PULSE OXIMETER as shown in this example) to the connected external medical device or return no device connected if the Line=0:
If line=1 connect VENTILATOR code
If Line=3 connect PULSE OXIMETER code
If Line=9 connect Multiparameter Monitor
If Line=0 return no medical device is connected

At this point, the device specific program module for the connected external medical device can take data from or give instructions to the external medical device.

Unless specifically stated otherwise as apparent from the following discussion, it is appreciated that throughout the description, discussions utilizing terms such as “processing” or “computing” or “calculating” or “delaying” or “comparing”, “generating” or “determining” or “forwarding or “deferring” “committing” or “interrupting” or “handling” or “receiving” or “buffering” or “allocating” or “displaying” or “flagging” or Boolean logic or other set related operations or the like, refer to the action and processes of a computer system, or electronic device, that manipulates and transforms data represented as physical (electronic) quantities within the computer system's or electronic devices' registers and memories into other data similarly represented as physical quantities within electronic memories or registers or other such information storage, transmission or display devices.

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The examples presented herein are intended to illustrate potential and specific implementations of the present disclosure. The examples are intended primarily for purposes of illustration of the invention for those skilled in the art. No particular aspect or aspects of the examples are necessarily intended to limit the scope of the present invention.

The figures and descriptions of the present invention have been simplified to illustrate elements that are relevant for a clear understanding of the present invention, while eliminating, for purposes of clarity, other elements. Those of ordinary skill in the art may recognize, however, that these sorts of focused discussions would not facilitate a better understanding of the present disclosure, and therefore, a more detailed description of such elements is not provided herein.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “loader,” “filter,” “platform,” or “component” may include various computers or computer systems, or may include a reasonable combination of software, firmware, and/or hardware.

In various embodiments of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure. Any of the servers, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it may be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present disclosure. Programming languages for computer software and other computer-implemented instructions may be translated into machine language by a compiler or an assembler before execution and/or may be translated directly at run time by an interpreter.

Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods, systems, and tools described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity.

Unless otherwise indicated, all numbers expressing lengths, widths, depths, or other dimensions and so forth used in the specification and claims are to be understood in all instances as indicating both the exact values as shown and as being modified by the term “about.” As used herein, the term “about” refers to a ±10% variation from the nominal value. Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Any specific value may vary by 20%.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

It will be appreciated by those skilled in the art that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. A method of detecting the presence of a specific medical device connected to a computer by an RS232 serial line, the method comprising the steps of:
providing an RS232 connector having a specified computer side output pin connected to specific device specified computer side input pins;
raising the voltage high on the specified computer side output pin;
determining which computer side input pins are voltage high; and
signaling which external medical device is in communication with the computer in response to which computer side input pins are voltage high.

2. The method of claim 1 wherein the computer side output pin is selected from one of the data terminal ready (DTR) and ready to send (RTS) pins.

3. The method of claim 1 wherein the computer side input pins are selected from one or more of data set ready DSR, data carrier detect (CD) and clear to send (CTS).

4. The method of claim 1 wherein the computer side output pin is connected to two or more computer side input pins.

5. A method of detecting the presence of a specific external device connected to a computer by an communication line, the method comprising the steps of:
providing an communication line connector having a specified computer side output pin connected to specific device specified computer side input pins;
raising the voltage high on the specified computer side output pin;
determining which computer side input pins are voltage high; and
signaling which external device is in communication with the computer in response to which computer side input pins are voltage high.

6. A connector for designating what type of external device is connected to a computer through a serial RS232 line, the connector comprising an RS232 connector in which at least one of the data terminal ready (DTR) and ready to send (RTS) pins is connected to one or more of data set ready DSR, data carrier detect (CD) and clear to send (CTS) in accordance to the type of external device connected to the computer.
